(19) United States
(12) Patent Application Publication
(10) Pub. No.: US 2025/0134267 A1
(43) Pub. Date: May 1, 2025

(54) FOLDABLE BED

(71) Applicant: PROLINE MEDICAL, St. Petersburg, FL (US)

(72) Inventors: Darrin Horst, St. Petersburg, FL (US); Zhou Pengfei, St. Petersburg, FL (US)

(73) Assignee: PROLINE MEDICAL, St. Petersburg, FL (US)

(21) Appl. No.: 18/924,383

(22) Filed: Oct. 23, 2024

(30) Foreign Application Priority Data
Oct. 25, 2023 (CN) 2023-22871627

(51) Int. Cl. A47C 19/12; A61G 7/018; A61G 7/05

(52) U.S. Cl. CPC A47C 19/122; A61G 7/018; A61G 7/0508

(57) ABSTRACT

The present invention discloses a foldable bed comprising a bed frame, a first railing, a second railing, and a folding assembly, wherein the bed frame includes a first connecting rod and a second connecting rod, the first connecting rod being rotatably connected to the first railing, the second connecting rod being rotatably connected to the second railing, the first connecting rod being connected to the second connecting rod by the folding assembly to have a foldable connection, and wherein the folding assembly includes a first folding piece and a second folding piece, the first folding piece being rotatably connected to the first connecting rod, the second folding piece being rotatably connected to the second connecting rod, and the first folding piece being rotatably connected to the second folding piece. An end of the first connecting rod nearest to the second connecting rod can be retracted upward and an end of the second connecting rod nearest to the first connecting rod can be retracted upwards, such that the first connecting rod and the second connecting rod are changed from a horizontal state to a vertical state, and the bed frame is changed from an unfolded state to a folded state. The foldable bed can thus be effectively folded, making it convenient to fold and store the bed.

### CROSS-REFERENCE TO RELATED APPLICATIONS

This application is based upon and claims the benefit of priority from the Chinese Patent Application No. 2023-22871627, filed on Oct. 25, 2023.

### BACKGROUND OF THE INVENTION

The present invention relates to a bed, specifically a foldable bed, more specifically a foldable nursing bed or foldable hospital bed.

A nursing bed is commonly used during patient rehabilitation and recuperation, and with the advancement of nursing beds, not only is a nursing bed often set up in the hospital, but a nursing bed is also often added in the patient's home. The nursing bed must be unfolded while the patient requires its use, but after the patient recovers and no longer requires its use, the unfolded nursing bed occupies a large amount of space and is inconvenient for the user to store.

### BRIEF SUMMARY OF THE INVENTION

The present invention aims to solve one of the problems existing in the prior art. To this end, an object of the present invention is to provide a foldable bed that is convenient for folding and storage.

The above object is achieved by the following technical scheme: a foldable bed comprising a bed frame, a first railing, a second railing, and a folding assembly, wherein the bed frame includes a first connecting rod and a second connecting rod, the first connecting rod being rotatably connected to the first railing, the second connecting rod being rotatably connected to the second railing, the first connecting rod being connected to the second connecting rod by the folding assembly to have a foldable connection, and wherein the folding assembly includes a first folding piece and a second folding piece, the first folding piece being rotatably connected to the first connecting rod, the second folding piece being rotatably connected to the second connecting rod, and the first folding piece being rotatably connected to the second folding piece.

As a further improvement of the present invention, the foldable bed comprises a first shock-absorbing assembly and a second shock-absorbing assembly, wherein the first shock-absorbing assembly includes a first support rod and a first linkage rod, the first support rod being connected to the first folding piece, one end of the first linkage rod being rotatably connected to the second railing, and an opposite end of the first linkage rod being rotatably connected to the first support rod, and wherein the second shock-absorbing assembly includes a second support rod and a second linkage rod, the second support rod being connected to the second folding piece, one end of the second linkage rod being rotatably connected to the first railing, and an opposite end of the second linkage rod being rotatably connected to the second support rod.

As a further improvement of the present invention, the foldable bed comprises a bed frame assembly, wherein the first shock-absorbing assembly includes a first torsion spring, the first torsion spring being arranged on the first support rod and counteracting with the bed frame assembly, and wherein the second shock-absorbing assembly includes a second torsion spring, the second torsion spring being arranged on the second support rod and counteracting with the bed frame assembly.

As a further improvement of the present invention, the bed frame assembly includes a first bed frame, a second bed frame, a first folding bed frame, and a second folding bed frame, the first bed frame being arranged at an end nearest to the first connecting rod, the second bed frame being arranged at an end nearest to the second connecting rod, the first folding bed frame and the second folding bed frame being arranged between the first bed frame and the second bed frame, the first folding bed frame being connected to the first folding piece, and the second folding bed frame being connected to the second folding piece.

As a further improvement of the present invention, the foldable bed comprises a first mounting frame and a first motor, wherein the first mounting frame is connected to the first connecting rod, the first motor is arranged on the first mounting frame, and an output end of the first motor is rotatably connected to the first bed frame.

As a further improvement of the present invention, the foldable bed comprises a first support, wherein the first support is connected to the first bed frame, and the first motor is rotatably connected to the first bed frame by rotation of the first support.

As a further improvement of the present invention, the foldable bed comprises a second mounting frame and a second motor, wherein the second mounting frame is connected to the second connecting rod, the second motor is arranged on the second mounting frame, and an output end of the second motor is rotatably connected to an end of the second bed frame nearest to the second folding bed frame.

As a further improvement of the present invention, the second bed frame is a rear bed frame including a first rear bed frame and a second rear bed frame, the first rear bed frame being arranged at an end nearest to the second folding bed frame, the second rear bed frame being arranged at an end farthest from the second folding bed frame, and the output end of the second motor being rotatably connected to the first rear bed frame.

As a further improvement of the present invention, the foldable bed comprises a second support, wherein the second support is connected to the first rear bed frame, and the second motor is connected to the first rear bed frame by the second support.

As a further improvement of the present invention, the first rear bed frame is rotatably connected to the second rear bed frame, the first rear bed frame is rotatably connected to the second folding frame, and the second folding frame is fixedly connected to the second folding piece.

As a further improvement of the present invention, the bed frame is configured to change between an unfolded state and a folded state, the first connecting rod and the second connecting rod being in a horizontal state when the bed frame is in the unfolded state, and the first connecting rod and the second connecting rod being in a vertical state when the bed frame is in the folded state.

As a further improvement of the present invention, in the vertical state the first connecting rod is connected to the first railing and the second connecting rod is connected to the second railing.

Compared with the prior art, the present invention provides at least the following beneficial effects:

The present invention provides a foldable bed, wherein the end of the first connecting rod nearest to the second connecting rod can be retracted upward and the end of the second connecting rod nearest to the first connecting rod can be retracted upwards, such that the first connecting rod and the second connecting rod are changed from a horizontal state to a vertical state and the bed frame is changed from an unfolded state to a folded state. The foldable bed can thus be effectively folded, making it convenient to fold and store the bed.

### BRIEF DESCRIPTION OF THE DRAWINGS

FIG. 1 is a structural schematic diagram of a foldable bed according to an embodiment of the present invention;

FIG. 2 is a magnified view of A in FIG. 1;

FIG. 3 is a magnified view of B in FIG. 1;

FIG. 4 is a schematic diagram of the decomposition of a foldable bed according to an embodiment of the present invention;

FIG. 5 is a schematic diagram of the structure of a bed frame according to an embodiment of the present invention;

FIG. 6 is a schematic diagram of the structure of a bed frame assembly according to an embodiment of the present invention;

FIG. 7 is a schematic diagram of the decomposition of a folding assembly according to an embodiment of the present invention;

FIG. 8 is a diagram of a foldable bed in a folded state according to an embodiment of the present invention; and

FIG. 9 is a schematic diagram of the decomposition of a foldable bed in a folded state according to an embodiment of the present invention.

### DETAILED DESCRIPTION OF THE INVENTION

The following examples illustrate the present invention, but the present invention is not limited by these examples. Modifications to the specific embodiment of the present invention or equivalent substitution of some technical features without departing from the spirit of the present invention should be included in the scope of the technical solution for which protection is claimed by the present invention.

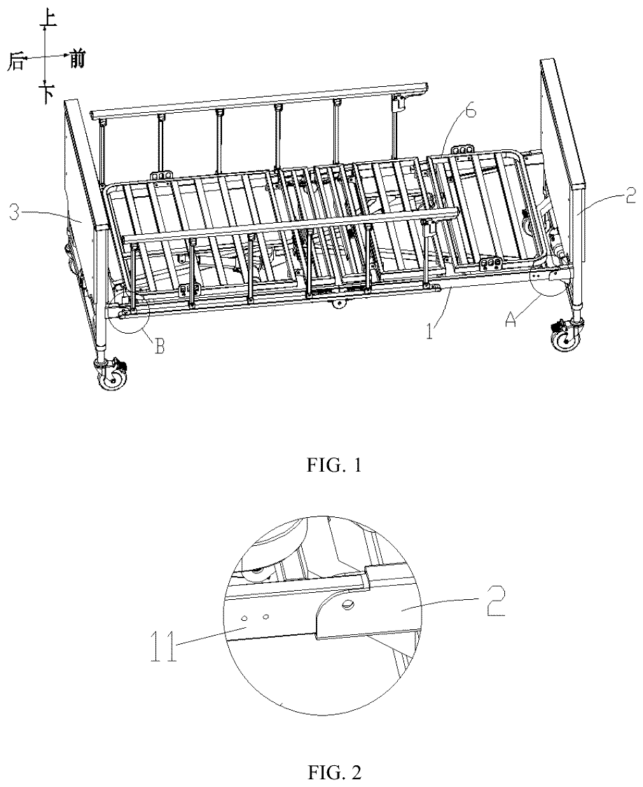

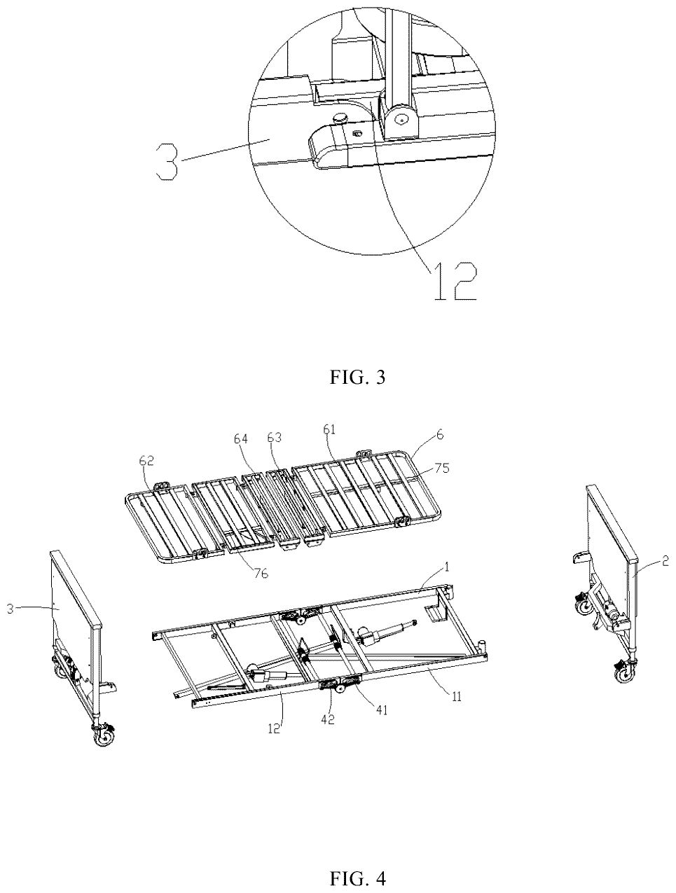

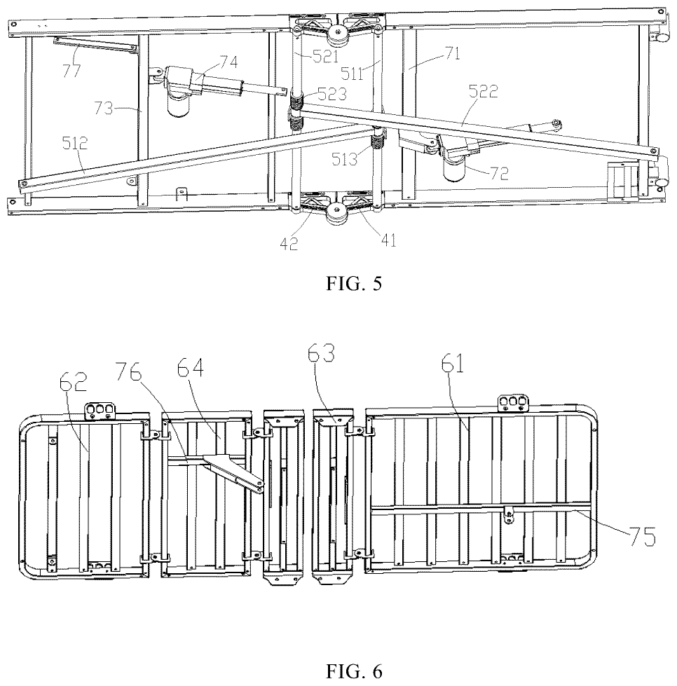

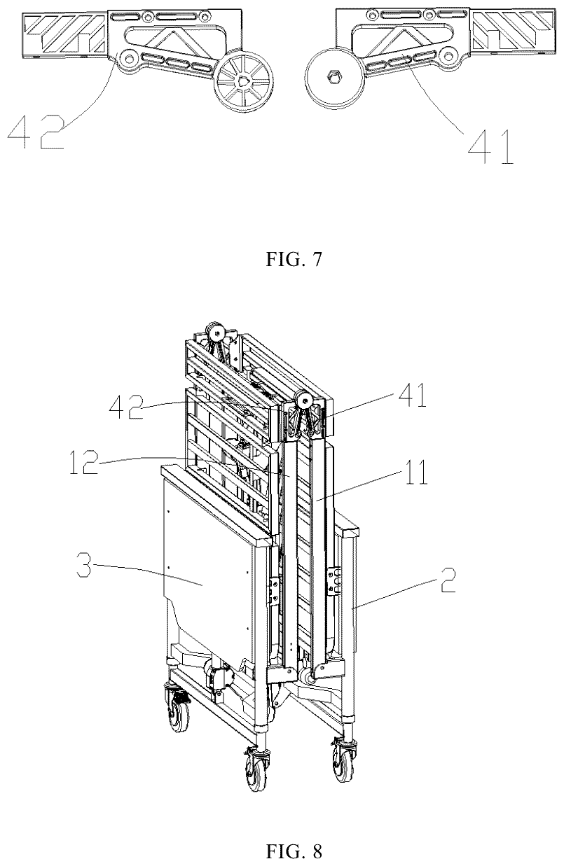

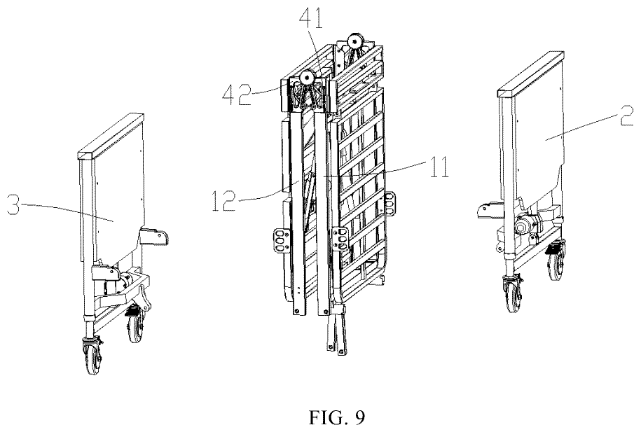

As shown in FIGS. 1-9, a foldable bed comprises a bed frame 1, a first railing 2, a second railing 3, and a folding assembly 4, wherein the bed frame 1 includes a first connecting rod 11 and a second connecting rod 12, the first connecting rod 11 being rotatably connected to the first railing 2, the second connecting rod 12 being rotatably connected to the second railing 3, the first connecting rod 11 being connected to the second connecting rod 12 by the folding assembly 4 to have a foldable connection, and wherein the folding assembly 4 includes a first folding piece 41 and a second folding piece 42, the first folding piece 41 being rotatably connected to the first connecting rod 11, the second folding piece 42 being rotatably connected to the second connecting rod 12, and the first folding piece 41 being rotatably connected to the second folding piece 42. In an embodiment of the present invention, the first railing 2 may be a head-side railing 2 and the second railing 3 may be a foot-side railing 3.

The present invention provides a foldable bed, wherein when the bed frame 1 needs to be folded up from the unfolded state, because the first connecting rod 11 is rotatably connected with the first railing 2, the second connecting rod 12 is rotatably connected with the second railing 3, and the first connecting rod 11 is connected with the second connecting rod 12 through the folding assembly 4 to have a foldable connection, the end of the first connecting rod 11 nearest to the second connecting rod 12 can be retracted upward, and the end of second connecting rod 12 nearest to the first connecting rod 11 can be retracted upwards, such that the first connecting rod 11 and the second connecting rod 12 are changed from a horizontal state to a vertical state and the bed frame 1 is changed from an unfolded state to a folded state. In the vertical state of the connecting rods and in the folded state of the bed, the first connecting rod 11 and the second connecting rod 12 may be configured to remain connected to, respectively, the first railing 2 and the second railing 3. The foldable bed can thus be effectively folded, making it convenient to fold and store the bed.

The present invention may further comprise a first shock-absorbing assembly 51 and a second shock-absorbing assembly 52, the first shock-absorbing assembly 51 including a first support rod 511 and a first linkage rod 512, the second shock-absorbing assembly 52 including a second support rod 521 and a second linkage rod 522, the first support rod 511 being connected to the first folding piece 41, the second strutting rod 521 being connected to the second folding piece 42, one end of the first linkage rod 512 being rotatably connected to the second railing 3, an opposite end of the first linkage rod 512 being rotatably connected to the first support rod 511, one end of the second linkage rod 522 being rotatably connected to the first railing 2, and an opposite end of the second linkage rod 522 being rotatably connected to the second support rod 521.

In an embodiment of the present invention, the connection between the first support rod 511 and the first folding piece 41 may be a fixed connection, and the connection between the second support rod 521 and the second folding piece 42 may be a fixed connection. The first linkage rod 512 and the second connecting rod 12 may be configured to move upward with the folding of the bed frame 1 to cooperate with the retraction, and the first linkage rod 512 and the second connecting rod 12 may be configured to move downward with the unfolding of the bed frame 1 to cooperate with the deployment.

The present invention may further comprise a bed frame assembly 6, wherein the first shock-absorbing assembly 51 includes a first torsion spring 513 and the second shock-absorbing assembly 52 includes a second torsion spring 523, the first torsion spring 513 being arranged on the first support rod 511 and counteracting with the bed frame assembly 6, and the second torsion spring 523 being arranged on the second support rod 521 and counteracting with the bed frame assembly 6.

When the bed frame 1 changes from a folded state to an unfolded state, meaning when the first connecting rod 11 and the second connecting rod 12 move downward from the vertical state to the horizontal state, the first connecting rod 11 and the second connecting rod 12 may easily sink downward under the influence of gravity and consequently make a loud slamming sound. By arranging the first torsion spring 513 on the first support rod 511 and arranging the second torsion spring 523 on the second support rod 521, the unfolding speed of the first connecting rod 11 and the second connecting rod 12 can be effectively slowed down in order to prevent the first connecting rod 11 and the second connecting rod 12 from unfolding too quickly under the influence of gravity and causing a loud slamming sound.

The bed frame assembly 6 may include a first bed frame 61, a second bed frame 62, a first folding bed frame 63 and a second folding bed frame 64, the first bed frame 61 being arranged close at an end nearest to the first connecting rod 11, the second bed frame 62 being arranged at an end nearest to the second connecting rod 12, the first folding bed frame 63 and the second folding bed frame 64 being arranged between the first bed frame 61 and the second bed frame 62, the first folding bed frame 63 being connected to the first folding piece 41, and the second folding bed frame 64 being connected to the second folding piece 42. The bed frame assembly 6 of the present invention may be a slatted deck frame assembly or a spring deck frame assembly. The first bed frame 61 may be a front bed frame and the second bed frame 62 may be a rear bed frame.

In an embodiment of the present invention, the first torsion spring 513 is arranged on the first support rod 511 and abuts against the first folding bed frame 63, and the second torsion spring 523 is arranged on the second support rod 521 and abuts against the second folding bed frame 64.

The present invention may further comprise a first mounting frame 71 and a first motor 72, wherein the first mounting frame 71 is connected to the first connecting rod 11, the first motor 72 is arranged on the first mounting frame 71, and the output end of the first motor 72 is rotatably connected to the first bed frame 61. The first motor 72 drives the first bed frame 61 to move upward. The first motor 72 may be a head motor.

In an embodiment of the present invention, the first bed frame 61 may be rotatably connected to the first folding bed frame 63, and the first folding bed frame 63 may be fixedly connected to the first folding piece 41. Driven by the first motor 72, since the end of the first bed frame 61 nearest to the first folding bed frame 63 cannot be moved due to its fixed connection to the first folding piece 41, the end of the first bed frame 61 farthest from the first folding bed frame 63 can be moved upward relative to the fixed end, so as to change the first bed frame 61 from a horizontal state to an inclined state. The inclined state entails that the first bed frame 61 is inclined downward from an end farthest from the first folding piece 41 to an end nearest to the first folding piece 41.

The present invention may further comprise a first support 75, wherein the first support 75 is connected to the first bed frame 61, and the first motor 72 is rotatably connected to the first bed frame 61 by rotation of the first support 75. The first support 75 may extend in a front-rear direction.

The present invention may further comprise a second mounting frame 73 and a second motor 74, wherein the second mounting frame 73 is connected to the second connecting rod 12, the second motor 74 is arranged on the second mounting frame 73, and an output end of the second motor 74 is rotatably connected to an end of the second bed frame 62 nearest to the second folding bed frame 64. The second motor 74 is configured to drive the end of the second bed frame 62 nearest to the second folding bed frame 64 to move upward. The second motor 74 may be a tail motor.

In an embodiment of the present invention, the second bed frame 62 may be a rear bed frame 62 including a first rear bed frame 62 and a second rear bed frame 62, the first rear bed frame 62 being arranged at an end nearest to the second folding bed frame 64, the second rear bed frame 62 being arranged at an end farthest from the second folding bed frame 64, and the output end of the second motor 74 is rotatably connected to the first rear bed frame 62. The second motor 74 may be configured to drive the rear bed frame 62, near the first rear bed frame 62, to move upward.

The present invention may further comprise a second support 76, wherein the second support 76 is connected to the first rear bed frame 62, and the second motor 74 is connected to the first rear bed frame 62 by the second support 76. In this embodiment, the second support 76 may extend in the front-rear direction, and the first rear bed frame 62 may be mobilized through the second support 76 to be linked together.

In an embodiment of the present invention, the first rear bed frame 62 is rotatably connected to the second rear bed frame 62, the first rear bed frame 62 is rotatably connected to the second folding frame 64, and the second folding frame 64 is fixedly connected to the second folding piece 42. When the second motor 74 drives the first rear bed frame 62 to move upward, the first rear bed frame 62 may change from a horizontal state to an inclined state, the inclined state being that the first rear bed frame 62 is inclined downward from an end nearest from the second folding frame 64 to an end farthest from the second folding frame 64.

The present invention may also comprise a third support 77, one end of the third support 77 being rotatably connected to the second mounting frame 73, and the other end being rotatably connected to the second rear bed frame 62.

When the second motor 74 drives the first rear bed frame 62 to move upward and change into an inclined state, with the connection of the third support 77, the end of the second rear bed frame 62 nearest to the third support 77 may be configured to move upward to change the second rear bed frame 62 into an inclined state, the inclined state being that the second rear bed frame 62 is inclined downward from an end nearest to the first rear bed frame 62 to an end farthest from the first rear bed frame 62.

In an embodiment of the present invention, the foldable bed may be a semi-electric foldable bed comprising a crank configured to raise the entire foldable bed. In another embodiment of the present invention, the foldable bed may be a fully-electric foldable bed comprising a third motor configured to raise the entire foldable bed.

The above-mentioned preferred embodiments shall be regarded as illustrative examples of the embodiments of the present application. Any technical deductions, substitutions, improvements, etc., that are identical or similar to the present application or made on the basis thereof shall be regarded as the scope of protection of the present patent.

1. A foldable bed, comprising:
a bed frame;
a first railing;
a second railing; and
a folding assembly,
wherein the bed frame includes a first connecting rod and a second connecting rod, the first connecting rod being rotatably connected to the first railing, the second connecting rod being rotatably connected to the second railing, the first connecting rod being connected to the second connecting rod by the folding assembly to have a foldable connection, and
wherein the folding assembly includes a first folding piece and a second folding piece, the first folding piece being rotatably connected to the first connecting rod, the second folding piece being rotatably connected to the second connecting rod, and the first folding piece being rotatably connected to the second folding piece.

2. The foldable bed of claim 1, comprising:
a first shock-absorbing assembly; and
a second shock-absorbing assembly,
wherein the first shock-absorbing assembly includes a first support rod and a first linkage rod, the first support rod being connected to the first folding piece, one end of the first linkage rod being rotatably connected to the second railing, and an opposite end of the first linkage rod being rotatably connected to the first support rod, and
wherein the second shock-absorbing assembly includes a second support rod and a second linkage rod, the second support rod being connected to the second folding piece, one end of the second linkage rod being rotatably connected to the first railing, and an opposite end of the second linkage rod being rotatably connected to the second support rod.

3. The foldable bed of claim 2, comprising:
a bed frame assembly,
wherein the first shock-absorbing assembly includes a first torsion spring, the first torsion spring being arranged on the first support rod and counteracting with the bed frame assembly, and
wherein the second shock-absorbing assembly includes a second torsion spring, the second torsion spring being arranged on the second support rod and counteracting with the bed frame assembly.

4. The foldable bed of claim 3, wherein the bed frame assembly includes:
a first bed frame,
a second bed frame,
a first folding bed frame, and
a second folding bed frame,
the first bed frame being arranged at an end nearest to the first connecting rod, the second bed frame being arranged at an end nearest to the second connecting rod, the first folding bed frame and the second folding bed frame being arranged between the first bed frame and the second bed frame, the first folding bed frame being connected to the first folding piece, and the second folding bed frame being connected to the second folding piece.

5. The foldable bed of claim 4, comprising:
a first mounting frame; and
a first motor,
wherein the first mounting frame is connected to the first connecting rod, the first motor is arranged on the first mounting frame, and an output end of the first motor is rotatably connected to the first bed frame.

6. The foldable bed of claim 5, comprising:
a first support,
wherein the first support is connected to the first bed frame, and the first motor is rotatably connected to the first bed frame by rotation of the first support.

7. The foldable bed of claim 4, comprising:
a second mounting frame; and
a second motor,
wherein the second mounting frame is connected to the second connecting rod, the second motor is arranged on the second mounting frame, and an output end of the second motor is rotatably connected to an end of the second bed frame nearest to the second folding bed frame.

8. The foldable bed of claim 7, wherein the second bed frame is a rear bed frame, the rear bed frame including:
a first rear bed frame, and
a second rear bed frame,
the first rear bed frame being arranged at an end nearest to the second folding bed frame, the second rear bed frame being arranged at an end farthest from the second folding bed frame, and the output end of the second motor being rotatably connected to the first rear bed frame.

9. The foldable bed of claim 8, comprising:
a second support,
wherein the second support is connected to the first rear bed frame, and the second motor is connected to the first rear bed frame by the second support.

10. The foldable bed of claim 8, wherein the first rear bed frame is rotatably connected to the second rear bed frame, the first rear bed frame is rotatably connected to the second folding frame, and the second folding frame is fixedly connected to the second folding piece.

11. The foldable bed of claim 8, comprising:
a third support;
wherein one end of the third support is rotatably connected to the second mounting frame, and an opposite end of the third support is rotatably connected to the second rear bed frame.

12. The foldable bed of claim 1, wherein the bed frame is configured to change between an unfolded state and a folded state, the first connecting rod and the second connecting rod being in a horizontal state when the bed frame is in the unfolded state, and the first connecting rod and the second connecting rod being in a vertical state when the bed frame is in the folded state.

13. The foldable bed of claim 12, wherein, in the vertical state, the first connecting rod is connected to the first railing, and the second connecting rod is connected to the second railing.
